(19) United States
(12) Patent Application Publication
(10) Pub. No.: US 2005/0108074 A1
(43) Pub. Date: May 19, 2005

(54) Method and system for prioritization of task items

(76) Inventors: Peter E. Bloechl, Goslar (DE); Markus G. Stolze, Adliswil (CH); Keith Whittingham, Langnau am Albis (CH)

Correspondence Address: LOUIS J. PERCELLO;IBM Corporation, Intellectual Propery Law Dept., P.O. Box 218, Yorktown Heighjts, NY, 10598, US

(21) Appl. No.: 10/713,931

(22) Filed: Nov. 14, 2003

(51) Int. Cl. G06F 17/60

(52) U.S. Cl. 705/8

(57) ABSTRACT

The present invention relates to a method and a system for improving the prioritization of task items of a user within task management systems as for instance in electronic calendar systems or workflow systems. The current invention suggests a computerized prioritization technology which evaluates a specification of an importance function associated with a task item and dynamically determines an importance value of the task item as a function of one or a multitude of context attributes. As the importance functions are reevaluated continuously based on the current values of the context attributes it is achieved that the priority values of task items are adapted dynamically and may change during their lifetime.

### 1. BACKGROUND OF THE INVENTION

1.1 Field of the Invention

The present invention relates to a method and a system for improving the prioritization of task items of a certain user as for instance required within an electronic calendar systems or workflow systems.

1.2 Description and Disadvantages of Prior Art

An electronic task management systems like for instance of electronic calendar systems have greatly proliferated as the use of personal computers has gained popularity. Electronic calendar systems allow a user to maintain a personal or group schedule on a day-to-day basis. Other calendar functions often include the ability to schedule meetings, check other calendars, prepare a personal memorandum applicable to a single date, and maintain a current “To-do list”

The user is generally provided with a time breakdown of each individual day in order to schedule and see events for that day. By utilizing pop up menus, drop down boxes, etc., the user may enter dates, times, attendees, and event descriptions for placement into the time breakdowns.

Many of today's desktop applications suites such as Lotus Notes/SmartSuite and Microsoft Office offer an integrated calendar system that also supplies collaborative functions such as group scheduling. Furthermore, with the proliferation of pervasive devices such as PDAs and smart phones more and more users are now in a position to carry along their electronic calendars independent of their desktop computer. The result of these developments is that maintaining an electronic calendar is has been getting more useful, more efficient and more convenient. Thus more people maintaining their calendars electronically. In some organizations it has become almost expected that employees maintain their calendar electronically and that they consult it as frequent as their e-mail. In essence such processing environments have become the focal point for electronic and computerized task management.

Almost all of today's calendaring applications support the maintenance of a “to-do” list of tasks. To-do list entries differ from the “normal” calendar entries (such as appointments and meetings) in that they do not have a fixed date and time at which they are scheduled. Instead, to-do list entries are “floating” entries that (after their start date) are carried from day to day until they are marked as “done”. Also, some applications allow to associate with each task additional information such as the due date, the logical group, the percentage to which a certain task has been completed, the total expected time for the task, and a priority (high, medium, or low). When viewing the task list, the information in each of these fields can be used to sort the tasks in the list according to the different aspects.

The problem with the state of the art technology is, that any such sorting is always only according to a single field—with the added difficulty that some fields (such a “priority”) only support a very coarse grained set of values. Therefore, for a person that has a large number of tasks in his or her list it will be difficult to determine which is the most important task to perform next.

1.3 Objective of the Invention

The invention is based on the objective to provide a more flexible technology for the prioritization of task items in a task list of a user.

### 2. SUMMARY AND ADVANTAGES OF THE INVENTION

The objectives of the invention are solved by the independent claims. Further advantageous arrangements and embodiments of the invention are set forth in the respective subclaims.

The present invention relates to a method and a system for improving the prioritization of task items of a user within task management systems as for instance in electronic calendar systems or workflow systems.

The current invention suggests a computerized prioritization technology which evaluates a specification of an importance function associated with a task item and dynamically determines an importance value of the task item as a function of one or a multitude of context attributes.

As the importance functions are reevaluated continuously based on the current values of the context attributes it is achieved that the priority values of task items are adapted dynamically and may change during their lifetime.

### 3. BRIEF DESCRIPTION OF THE DRAWINGS

FIG. 1 to 3 show examples reflecting various basic patterns how task items are varying their importance values during their lifetime.

FIG. 4 illustrates a set of scenarios reflecting certain aspects of the proposed task management system.

### 4. DESCRIPTION OF THE PREFERRED EMBODIMENT

In the drawings and specification there has been set forth a preferred embodiment of the invention and, although specific terms are used, the description thus given uses terminology in a generic and descriptive sense only and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

4.1 Introduction

The current invention is based on the observation of the following limiting characteristics of state of the art task management systems as provide by electronic calendar systems. Moreover first indications for an appropriate solution are provided.
1. While state of the art task management systems allow to associate task items with a priority indication this is possible in a static manner only. The priority assigned to a task item is constant throughout the whole lifetime of the task item; that is, only fixed priority schemes do exist. What would be required is a prioritization technology allowing to automatically and dynamically adapt the priority value of a certain task item during its lifetime.
2. A further difficulty is that such priority assignments according to the state of the art are made independent of the importance of other task items currently making up the concrete task item list of a certain user. Thus, required is a prioritization technology allowing to dynamically calculate the importance of a certain task item dependent on its current context; that is, dependent on the importance of all the other task items making up the user's current task item list. Without such an context-sensitive and self adaptive prioritization approach “Unbalanced” task lists may result. For instance, many task items are indicated as being of almost equal importance not allowing a user to distinguish between these to select the most important. Or as another example, task items may become outdated with the result that their priority indication has become completely irrelevant.

The most important observation to achieve this context-sensitivity and self-adaptiveness is to implement the priority of a task item not as a simple value but as a function, called importance function in the following. If this importance function is defined by a specification it can be evaluated continuously to determine the current priority, called importance value in the following, dependent on any appropriate set of context attributes. The scope and nature of these context attributes are not limited according to the current invention; thus, the context attributes of a certain task item might comprise attributes specific to this particular task item but also might comprise attributes shared with other task items or even comprise attributes governing the dependency and relationship between different task items. Due to this prioritization approach based on importance functions a multi-dimensional weighting of the individual influences of the context attributes onto the overall priority can be achieved, being in a clear contrast to the state of the art based on the various sorting approaches for single variables of only.

4.2 Context Sensitive and Self Adaptive Prioritization By Importance Functions

The invention thus suggests a new feature for task management systems, namely the use of a continuous priority scheme of tasks, which automatically adjusts the priorities of tasks according to a user-defined specifications of importance functions. Thereby the rearrangement (for instance on a manual basis by the user) of priorities is no longer needed and nevertheless the priorities are not outdated. This technology can be integrated for instance into any electronic calendar system like Lotus Notes or into any other task-monitoring or-management system as well as workflow systems.

The approach suggested according to the current invention solves these problems by allowing the user to define the “importance” of a task as an importance function that takes as input the currently available information about the user's context and returns as the result a number for instance between 0 and 1 specifying the importance of the task. Thus, formally an importance function I(context_attributes) is a mapping C->[0,1] with C={c1, . . . , cn} being the set of context variables used by the function I( ). Important examples for prominent context variables are the current date, the number of days until the deadline of a task, the current time of the day, and the current location.

A simple importance function only uses a single context variable to determine an importance value. An example of such a simple importance function is a function that defines a mapping from the current date and time to the importance of a task.

It is pointed out that the concrete function of how these context attributes influence the importance values is not essential to the current invention, actually any functional relationship may be choose. Essential to the current invention is only the fact that the importance value is determined dynamically by an evaluation of an importance function. The concrete selection of the context attributes and their concrete functional relationship within the importance function can be chosen according to the circumstances.

A further aspect of the suggested invention is that the importance values of the task items are reevaluated continuously (that is, repeatedly or for instance periodically) based on and exploiting the current values of the context. After every reevaluation the determined importance values are being used as priority of the task items and these importance values are finally indicated to the user.

In a further improved implementation of this invention the importance values are being determined also as a function of other task items in the current task list of the user. The importance function for a certain task item of a first user might even depend on task items of other users. This teaching allows to consider dependencies between the task items with respect to their influence on the corresponding importance values and thus contributes a further aspect of dynamic and context sensitive adaptation. For instance, creation of a new task item or removal of an existing task item will influence the importance values of other task items of that or other users.

Once the task items have been associated with specifications of importance functions these specification are modifiable by the user. For instance users can be allowed to specify such importance functions interactively using a 2D graph editor. In a further improvement the specifications even may be modifiable by the task items themselves dependent on the access behavior to the task items by said user. To give an example, if the task item is being selected by a user to work on it while other task items with higher importance values are skipped, this can result in an automatic and transparent adaptation of the corresponding specification of the importance function thus that based on the current context attributes a higher importance value would be achieved.

In a further embodiment of the invention the specification of the importance function even may be enabled to automatically trigger new task items dependent on the current values of context attributes and/or the importance value of the task item. Some concrete examples of this embodiment will be given together with appointment items below.

As context attributes participating within the importance the following parameters have been proven to be most effective:
a. the estimated required work time to perform a task item;
b. the time already spent for work on a task item;
c. the indicator, whether work on a task item has been started by the user;
d. a dependency attribute indicating the order of precedence with related task-items; Such an attribute allows to control, whether a certain task item has been completed before other task items may be performed or vice versa.
e. the deadline for completing a task-item;
f. an attribute reflecting expected losses for finishing said task-item too late; Such an parameters allows to control the expected costs of finishing a task item too late by allowing to influence the priority of the corresponding task items.
g. an attribute reflecting expected benefits for finishing said task-item before its deadline;
h. relationships to tasks of other individuals;
i. attributes modeling professional, organizational or personal goals;

In yet another embodiment of the current invention the importance function is also dependent on the type of the task items. For that purpose the following types of task items typically can be distinguished:
A. appointment items;
B. to-do items;
C. work item of a Workflow system;
D. reminder items to remind the user of an event;
E. e-mail items requiring a reaction by the user;

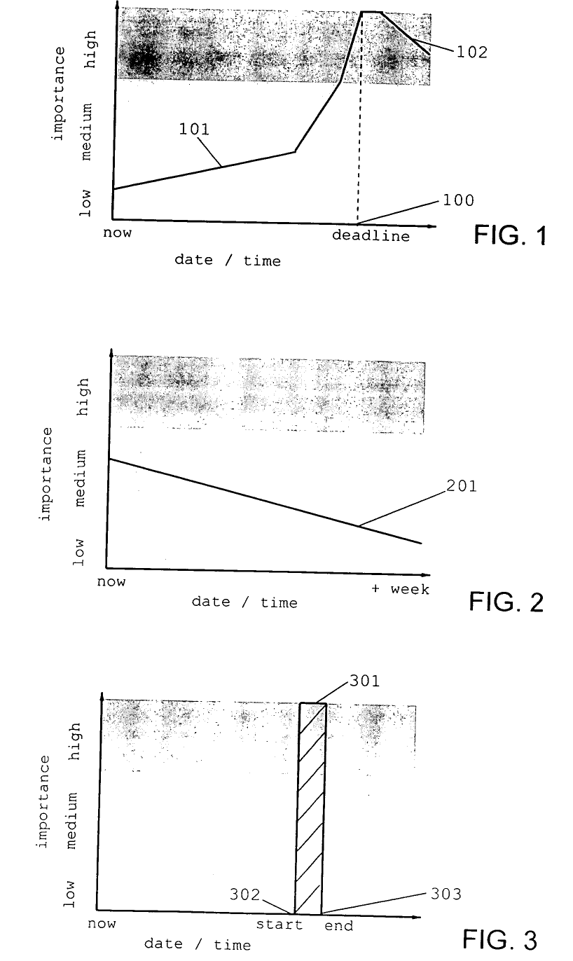

With respect to the variances of the importance value of a certain task item during said task item's lifetime a set of basic “Aging” patterns are suggested:
1. In a first approach the continuously reevaluated importance function is returning a “high” importance value larger than all importance values of all other task items of a user, if the estimated required work time for said task item is larger than the time available to said user until the deadline for completing this task item. The determination of the available time to the user even is taking into account the estimated required work times of other task items to be completed before said deadline by the same user. Based on this aging pattern the user will be triggered to focus his activities onto such a critical task item as early as possible.
2. In a second approach the continuously reevaluated importance function is returning a steadily increasing importance value as a deadline for completing a task item is approaching. Expressed in other words: a task with a specified deadline will get more important the closer the deadline gets. FIG. 1 is visualizing such an example. The x axis is indicating the time while the y axes reflects the importance value for each point in time. Point 100 represents the deadline for completing a task item. Part 101 of the importance function shows such a steadily increasing importance value behavior approaching the predefined deadline.
3. In a third approach the continuously reevaluated importance function is returning a steadily decreasing importance value as the deadline for completing a task item has been passed. Again by referring to FIG. 1 this aging behavior is depicted in branch 102.
4. In a fourth approach the continuously reevaluated importance function is returning a steadily decreasing importance value after creation of said task item. FIG. 2, using the same notion for the x and y axes as FIG. 1, is visualizing exactly such an example by branch 201.

The task items can be represented as a graph of the importance level versus time for instance, providing a simple transparent visualization for the user. A user will watch his task list and naturally select to work on the item with current maximum importance; that is, typically the user will decide to work on task that has the highest importance level. The representation may show the areas, importance versus time, where the total importance is normalized to 100%, and a second graph may show the overall workload, with its accumulations of tasks during certain periods.

Moreover it is suggested that the “history” of the task management system remembers which tasks have been performed during which times, and may store certain behavioral patterns relative to the state of the task management system (like for instance the current time). If for instance a certain task item type has been completed only very shortly before its deadline, the specification relating to the importance function can be modified such that in the future task items of this type will raise their importance values much it a little when approaching the deadline. This prevents that a user will get short in time while a deadline is approaching. Or as a further example the system may analyze previous work patterns and alert driven by previous experience, if a new task that however is in a certain way repetitive is entered.

4.3 Types of Task Items and their Importance Functions

The current invention provides an unified approach to handle all types of task items within a common context of a task management system. As a the result it is suggested to treat different task item types differently with respect to the definition of the importance function. The following will focus on the various task item types individually.

4.3.1 Appointment Items

An appointment item is a task item to model a certain appointment event. The current invention suggests to associate an importance function with appointment items which is returning a high importance value larger than all importance values of all other task items for the duration of the appointment. In one embodiment this means that the importance function is defined such that a maximum importance level for a fixed period of time, namely during the duration of the appointment, is associated with the appointment item; this approach is depicted within FIG. 3 by the importance function 301 over the time period defined by the start 302 and the end 303 of the appointment. Moreover it is suggested to trigger a further task item, namely a reminder item, at a first predefined time before the appointment that alerts the user of the upcoming appointment a fixed time before the meeting. Yet its is further suggested to trigger a further task item, namely a to-do item at the second predefined time before said appointment to track a user's preparation task for the appointment. During the appointment all other task items during this time period are given zero importance (or at least and a very low importance), thus defining a functional dependence on other task items. An appointment item can also be enabled to block the creation of conflicting other appointment items in or other task items in general. This blockage can be a realized also in a more “soft” way, by specifying relative precedence of the appointments and/or a task to resolve the conflict in the task management system.

4.3.2 To-Do Items

A to-do item is a task item to model the aspects of some general work to be completed by a user. It is suggested to model a to-do item by a small constant importance for a indefinite time period and an estimated effort attribute and possibly a deadline attribute. A to-do item would gain large importance if there are no other superseding commitments. That implies that its importance level is to a large part dependent on other calendar entries. If a deadline attribute is associated with a to-do item it is beneficial to associate an importance function with the to-do item according to FIG. 1; that is, the importance value would be steadily increased as the deadline is approached and the importance value is steadily decreased afterwards.

4.3.3 Workflow Items

Workflow items are task items distributed by a workflow management system to individual users for performing certain steps within a larger and more complex process model. Typically a workflow item is characterized by a deadline attribute, an estimated work time attribute and an attribute reflecting the amount of work already spent on this workflow item. It is suggested that importance value of a workflow item would reach maximum importance if the estimated effort until the deadline is larger than the “available” work time of the user, that is the time not occupied by appointments, non-work time, etc. The context attributes of a workflow item typically models a strong dependency on other workflow items (for instance those of other colleagues), which will be acknowledged during the evaluation of the importance functions.

4.3.4 E-Mail Items

An e-mail item is a task item requiring a reaction by the receiving user. According to the current teaching answering an e-mail is associated with another type of importance function for which the importance of acting on it becomes less the longer the user is not responding to the e-mail; in other words, the importance function is returning a steadily decreasing importance value after creation of the e-mail item. Such an importance function is visualized within FIG. 2.

4.4 Further Enhancements

The challenge of task management systems is to make it manageable by users and to minimized the effort needed to achieve a sensible and self-adjusting system behavior. Therefore it is further suggested that the task management system automatically assigns a specification of a default importance function that is derived from the properties of a task item such as the start date, the due date, and the static priority of the task. Also the past history of user adjustments to proposed functions during the past and observations of dynamic user behavior (the users of access patterns) are influencing of the process of assigning the default importance function. A further source of information for defining the default importance function are the relationship of the new task to task items performed by coworkers. Finally the importance of the overall goal the new task item is contributing to can be determined to contribute to the default importance function.

Things get slightly more complex if users want to specify more than one importance function for a task. So, for example, users might want to specify that in addition to the already specified evolution of the importance over time, this is a task that he/she prefers to do in the morning. To deal with such an additional importance function a combination function (for instance a multiplication) can be specified that combines the importance values of the two simple (or more) simple importance values into a single value between 0 and 1. But independent how complex the circumstances are the solution to this flexibility problem may always be reduced to a single importance function with a degree of complexity in tight correspondence to the real world problem to be solved.

Also other contextual variables (making up the scope of context attributes) can be used to determine the current importance of a task. For example, an electronic calendar of a smart phone might have information about the person currently calling and therefore might bring to the front tasks that are associated with that person (by reevaluating their importance function). Also location information can be available in such phones and tasks that are associated with certain locations like “office”, “home”, or “super market” can receive a high importance rating (which might trigger user notification) because the system detects that the user has entered the associated location.

An interesting aspect of the proposed technology is that it enables a smooth integration with generic workflow systems. Here tasks can be dispatched to individual workers as a to-do item. Already the dispatching process can take into consideration the load of the individual worker as well as his or her abilities. The importance of such a task should then be determined as a function of the urgency of the containing workflow.

4.5 Typical Scenarios within the Proposed Task Management System

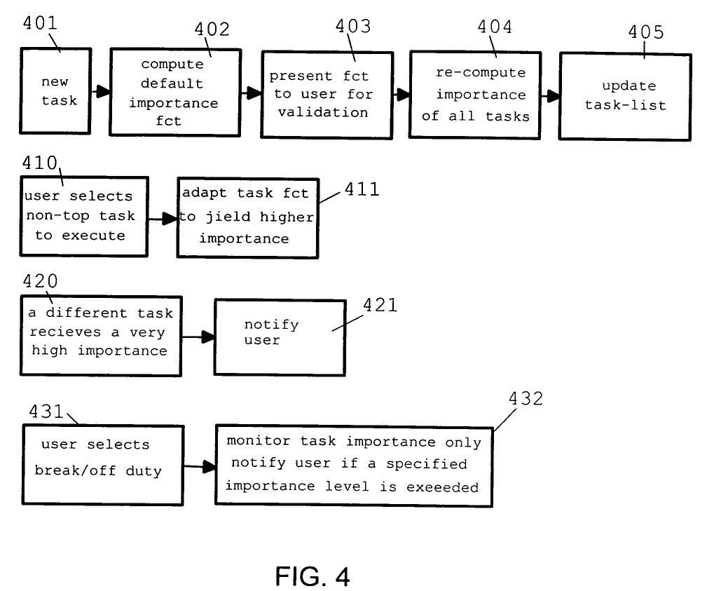

Referring to FIG. 4 a set of scenarios are discussed reflecting certain aspects of the proposed task management system.

The first scenario being part of FIG. 4 relates to the standard processing of the task management system according to the current invention.

401 reflects a new task item created by the user within the task management system. As described above the task management system computes a default importance function within step 402 and associates it with the new task item. The default importance function is determined based on the specific context attributes chosen by the user and on the type of task item. In step 403 the user may modify the specification defining the importance function. Once the importance function has been defined it is exploited within step 404 to compute the importance value of the new task item as well as to re-compute the importance value of all other task items in the task list. This recomputation is a consequence of the fact that (in the extreme case) the importance value of a certain task item may be influenced by all other task items in the task list.

Finally, in step 405 the task list is updated to reflect the new task item together with the importance values of the new and existing task items. The sequence of steps 404 and 405 is repeated iteratively to realize a dynamic and self adjusting behavior of the task management system reflecting the influence of changed context attributes onto the individual importance values.

The second scenario being part of FIG. 4 relates to a situation where the task management system monitors the user's access behavior to transparently adapt the task functions associated with the task items.

Within step 410 it is assumed that a user selects a task item to work on it whose importance value is not the largest one. As this is a deviation with respect to the natural assumption that a user would select the most important task item to work with, the task management system concludes within step 411 that the corresponding importance function has to be adapted resulting in an increased importance value.

The third scenario being part of FIG. 4 addresses the situation that after a recomputation of the importance values a certain task item suddenly receive a very high importance value as reflected in step 420. The task management system's response is to notify the user on this sudden change within step 421.

The fourth and last scenario being part of FIG. 4 relates to situation wherein a user indicates to the task management system that he/she is off duty depicted in the step 431. In this situation the task management system changes its mode of processing instead of stopping its processing at all. The task management system is still re-computing the importance functions of all task items within the background. But within this specific situation the task management system tries to avoid to bother the user with notifications and therefore limits notifications to situations only wherein importance values of task items exceed a critical importance level. This processing is visualized within step 432.

1. Computerized prioritization method of at least one task-item said method comprising
a step of evaluating a specification of an importance-function associated with said task-item and dynamically determining an importance-value of said task-item as a function of one or a multitude of context-attributes.

2. Computerized prioritization method according to claim 1,
wherein said importance-value being reevaluated continuously based on the current values of said one or multitude of context-attributes; and
wherein said importance-value being used as priority of said task-item and said importance-value being indicated to a user in correspondence with said task-item.

3. Computerized prioritization method according to claim 2,
wherein said step of evaluating is determining said importance-value also as function of other task-items in a task-list of said user for considering dependencies between said task-item and said other task-items.

4. Computerized prioritization method according to claim 3,
wherein said one or multitude of context-attributes comprise the current time.

5. Computerized prioritization method according to claim 2, said method further comprising
a step of associating said task-item with said specification proceeding said the step of evaluating.

6. Computerized prioritization method according to claim 5,
wherein said specification being modifiable by said user; and/or
wherein said specification being modifiable by said task-item itself dependent on the access behavior to said task-item by said user.

7. Computerized prioritization method according to claim 4,
wherein said specification is capable of automatically triggering a new task-item said triggering being dependent on the current values of said one or multitude of context-attributes and/or on said importance-value of said task-item.

8. Computerized prioritization method according to claim 4,
wherein said step of evaluating is determining said importance-value also as function of a type of said task-item.

9. Computerized prioritization method according to claim 8,
wherein possible types of said task-items are:
an appointment item; or
a to-do item; or
a work item of a Workflow system; or
a reminder item to remind said user of an event; or
an e-mail item requiring a reaction by said user.

10. Computerized prioritization method according to claim 9,
wherein said one or multitude of context-attributes comprising one or a multitude of the following set of potential context-attributes:
an estimated required work time to perform said task-item; and/or
a time already spent for a task-item; and/or
an indicator, whether work on a task item has been started by said user; and/or
a dependency attribute indicating order of precedence with related task-items; and/or
a deadline for completing a task-item; and/or
an attribute reflecting expected losses for finishing said task-item too late; and/or
an attribute reflecting expected benefits for finishing said task-item before its deadline.

11. Computerized prioritization method according to claim 10,
wherein said importance-function is returning a high importance-value larger than all importance-values of all other task-items of said user, if an estimated required work time for said task-item is larger than the available time to said user until said deadline, taking into account estimated required work times of other task-items to be completed before said deadline; and/or
wherein said importance-function is returning a steadily increasing importance-value as a deadline for completing said task-item is approaching; and/or
wherein said importance-function is returning a steadily decreasing importance-value as a deadline for completing said task-item has been passed; and/or
wherein said importance-function is returning a steadily decreasing importance-value after creation of said task-item.

12. Computerized prioritization method according to claim 10,
wherein said task-item is an appointment item and said importance-function is returning a high importance-value larger than all importance-values of all other task-items for the duration of said appointment.

13. Computerized prioritization method according to claim 12,
wherein said specification of said appointment item
is triggering a reminder item at a first predefined time before said appointment; and/or
is triggering a to-do item at the second predefined time before said appointment to track said user's preparation task for said appointment.

14. Computerized prioritization method according to claim 1,
wherein said method is being executed by a ask management system.

15. Computerized prioritization method according to claim 14,
wherein said task management system is an electronic calendar system; and/or
wherein said task management system is a Workflow system.

16. Computerized prioritization method according to claim 2,
wherein said continuously reevaluatated importance-value being indicated visually to said user.

17. A computer system comprising means adapted for carrying out the steps of the method according to claim 1.

18. A data processing program for execution in a data processing system comprising software code portions for performing a method according to claim 1 when said program is run on said computer.

19. A computer program product stored on a computer usable medium, comprising computer readable program means for causing a computer to perform a method according to claim 1 to 16 when said program is run on said computer.
